(19) United States
(12) Patent Application Publication
(10) Pub. No.: US 2020/0092931 A1
(43) Pub. Date: Mar. 19, 2020

(54) RADIO COMMUNICATION APPARATUS AND RADIO COMMUNICATION TERMINAL

(71) Applicants: Kabushiki Kaisha Toshiba, Tokyo (JP); Toshiba Electronic Devices & Storage Corporation, Tokyo (JP)

(72) Inventor: Kenichi Agawa, Yokohama Kanagawa (JP)

(21) Appl. No.: 16/266,146

(22) Filed: Feb. 4, 2019

(30) Foreign Application Priority Data
Sep. 14, 2018 (JP) 2018-172722

(51) Int. Cl. H04W 76/16

(52) U.S. Cl. CPC H04W 76/16; H04W 88/06

(57) ABSTRACT

According to an embodiment, a radio communication apparatus includes a microwave radio unit, a millimeter wave radio unit, and a control unit. The microwave radio unit transmits data using microwaves. The millimeter wave radio unit transmits the data using millimeter waves. The control unit performs control of switching as to whether to transmit the data using the microwaves or the millimeter waves depending on a transmission time period calculated from a mode selected in transmitting the data using the microwaves and a size of the data.

### CROSS-REFERENCE TO RELATED APPLICATION

This application is based upon and claims the benefit of priority from the prior Japanese Patent Application No. 2018-172722 filed on Sep. 14, 2018; the entire contents of which are incorporated herein by reference.

### FIELD

An embodiment described herein relates generally to a radio communication apparatus and a radio communication terminal.

### BACKGROUND

Conventionally, radio communication apparatuses using microwaves having a frequency between 1 GHz and 30 GHz have been widespread. As one example of such radio communication using microwaves, proximity radio communication such as TransferJet has been put into practical use. Recently, radio communication apparatuses using millimeter waves having a frequency of 30 GHz or higher have been put into practical use in order to transmit/receive a larger amount of data.

In the future, radio communication apparatuses will be widespread which include a function of radio communication using microwaves and a function of radio communication using millimeter waves, and are capable of transmitting data by switching radio communication using microwaves and radio communication using millimeter waves.

In general, a millimeter wave has characteristics of travelling in a straighter line than a microwave, and of being able to transmit a larger amount of data than a microwave.

However, when switching is made from radio communication using microwaves to radio communication using millimeter waves, communication environment of millimeter waves is often less stable than communication environment of microwaves in general. Therefore, a problem exists that when radio communication using millimeter waves has failed, it is necessary to perform radio communication using microwaves after establishment of a communication link using microwaves, so that it takes an extra time period to transmit data.

### BRIEF DESCRIPTION OF THE DRAWINGS

FIG. 1 is a block diagram showing a configuration of a radio communication terminal including a radio communication apparatus according to an embodiment;

FIG. 2 is a diagram showing an example of amounts of transmittable data depending on modes;

FIG. 3 is a flowchart showing an example flow of switching processing between transmission using microwaves and transmission using millimeter waves;

FIG. 4 is a diagram showing an example of conventional switching processing between microwaves and millimeter waves; and

FIG. 5 is a diagram showing an example of switching processing between microwaves and millimeter waves in the embodiment.

### DETAILED DESCRIPTION

A radio communication apparatus of an embodiment includes a microwave radio unit, a millimeter wave radio unit, and a control unit. The microwave radio unit transmits data using microwaves. The millimeter wave radio unit transmits data using millimeter waves. The control unit performs control of switching as to whether to transmit data using microwaves or millimeter waves depending on a transmission time period calculated from a mode selected in transmitting data using microwaves and the size of the data.

An embodiment will be described below in detail with reference to the drawings.

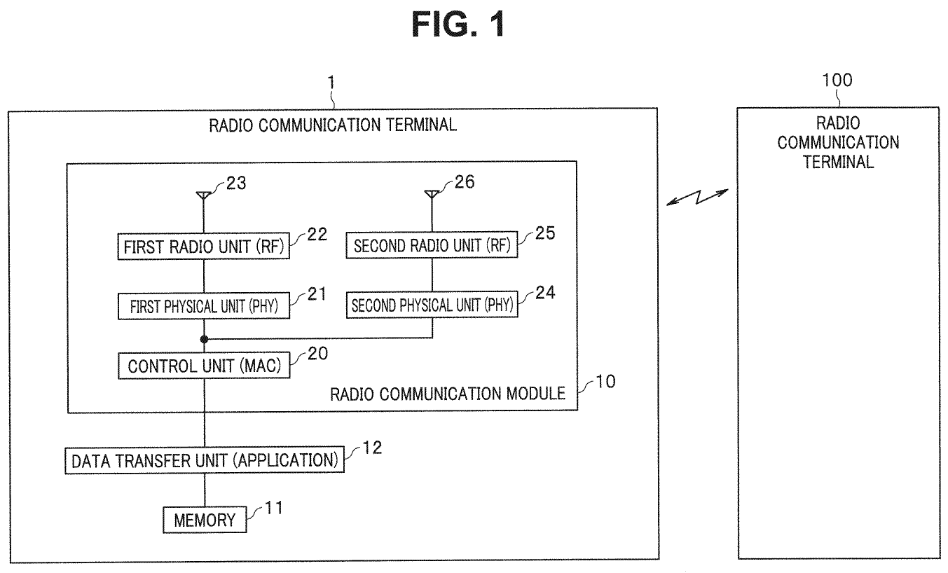

First, a configuration of a radio communication terminal including a radio communication apparatus according to an embodiment will be described based on FIG. 1. FIG. 1 is a block diagram showing a configuration of a radio communication terminal including a radio communication apparatus according to an embodiment.

A radio communication terminal 1 is composed of a radio communication module 10 as the radio communication apparatus, a memory 11, and a data transfer unit 12. The radio communication terminal 1 is a mobile terminal such as a smartphone or a tablet, and can communicate data by wireless with another radio communication terminal 100.

The radio communication module 10 is composed of a control unit 20, a first physical unit 21, a first radio unit 22, a first antenna 23, a second physical unit 24, a second radio unit 25, and a second antenna 26.

Data for transmission such as a still image or a movie file is stored in the memory 11 as a storage unit. In response to, for example, a user's instruction, the data transfer unit 12 reads the data for transmission from the memory 11 and transfers the data to the control unit 20 in the radio communication module 10.

The control unit 20 calculates a transmission time period according to the size of the data for transmission and a mode in transmitting data using microwaves, and switches as to whether to transmit the data for transmission using microwaves or millimeter waves based on the calculated transmission time period. Note that switching processing of switching as to whether to transmit the data for transmission using microwaves or millimeter waves will be described later. The control unit 20 outputs the data for transmission to the first physical unit 21 when transmitting data using microwaves, and outputs the data for transmission to the second physical unit 24 when transmitting data using millimeter waves.

The first physical unit 21 performs various signal processings such as encryption processing, modulation processing, and D/A conversion processing on the data for transmission, and outputs an obtained analog signal to the first radio unit 22 as a transmission signal. The first radio unit 22 as the microwave radio unit transmits the transmission signal from the first antenna 23 to the other radio communication terminal 100 using microwaves having a frequency between 1 GHz and 30 GHz.

When data is transmitted from the other radio communication terminal 100 using microwaves, the first radio unit 22 receives data via the first antenna 23 and transmits the data to the first physical unit 21. The first physical unit 21 performs various signal processings such as decryption processing of cipher, demodulation processing, and A/D conversion processing on the received data, and outputs an obtained digital signal to the control unit 20 as a received signal.

Similarly to the first physical unit 21, the second physical unit 24 performs various signal processings such as encryption processing, modulation processing, and D/A conversion processing on the data for transmission, and outputs an obtained analog signal to the second radio unit 25 as a transmission signal. The second radio unit 25 as the millimeter wave radio unit transmits the transmission signal from the second antenna 26 to the other radio communication terminal 100 using millimeter waves having a frequency of 30 GHz or higher.

When data is transmitted from the other radio communication terminal 100 using millimeter waves, the second radio unit 25 receives data via the second antenna 26 and transmits the data to the second physical unit 24. The second physical unit 24 performs various signal processings such as decryption processing of cipher, demodulation processing, and A/D conversion processing on the received data, and outputs an obtained digital signal to the control unit 20 as a received signal. The control unit 20 can store the received signal output from the first physical unit 21 or the second physical unit 24 in the memory 11 via the data transfer unit 12.

Thus, the radio communication module 10 of the embodiment includes the first radio unit 22 as the microwave radio unit and the second radio unit 25 as the millimeter wave radio unit, and can transmit data using microwaves or millimeter waves depending on a transmission time period expected in transmission using microwaves.

Here, switching processing of switching as to whether to transmit the data for transmission using microwaves or millimeter waves will be described.

When receiving the data for transmission from the data transfer unit 12, the control unit 20 establishes a communication link using microwaves, and determines a mode for transmission. For example, five modes exist in TransferJet in which microwaves are used for transmission.

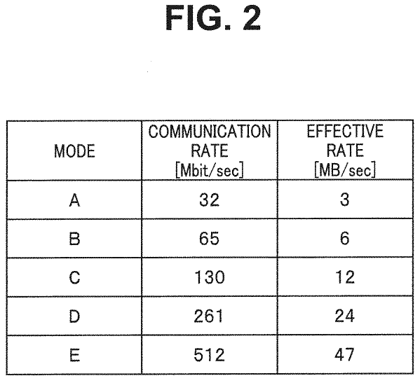

FIG. 2 is a diagram showing an example of amounts of transmittable data depending on modes. As shown in FIG. 2, five modes are referred to as a mode A, a mode B, a mode C, a mode D, and a mode E. The five modes are selected depending on communication quality. For example, a function to monitor quality of radio communication is provided, and the control unit 20 selects a mode depending on the monitored quality of radio communication. Note that the control unit 20 may be configured to select a mode depending on the number of times of occurrence of an error in data during communication. The control unit 20 selects the mode E when the communication quality is good, and selects a mode in the order of the mode D, the mode C, the mode B, and the mode A as the communication quality gets worse.

The mode A with worst communication quality has a communication rate of 32 Mbit/sec, and the mode E with best communication quality has a communication rate of 512 Mbit/sec. Some data is transmitted only once in the mode E with the best communication quality, whereas the same data is transmitted sixteen times in the mode A with the worst communication quality. That is, in the mode E with the best communication quality, it is possible to transmit sixteen times data of the mode A with the worst communication quality.

An effective rate is about 74% to 75% of a communication rate, and the effective rate in the mode A is 24 Mbit/sec. Here, when translated into byte representation, 24 Mbit/sec becomes 3 MB/sec, and 3 MB of data can be transmitted per second in the mode A.

Similarly, 6 MB of data can be transmitted per second in the mode B, 12 MB of data can be transmitted per second in the mode C, 24 MB of data can be transmitted per second in the mode D, and 47 MB of data can be transmitted per second in the mode E.

That is, when data of 3 MB or less is transmitted using microwaves, the data can be transmitted within one second. For example, when the mode C is selected and data to be transmitted is less than or equal to 12 MB, the data can be transmitted within one second. When the mode E is selected and data to be transmitted is less than or equal to 47 MB, the data can be transmitted within one second.

The control unit 20 calculates the transmission time period from the size of data to be transmitted and a mode in transmitting data using microwaves. The control unit 20 transmits data using microwaves when the transmission time period is less than or equal to a predetermined value (e.g., one second). That is, if data can be transmitted within one second even when transmitted using microwaves, a transition to millimeter waves is not made. Note that although the control unit 20 may perform the control alone, the control may be performed in cooperation with, for example, a control function existing in the radio communication terminal 1.

The control unit 20 calculates the transmission time period from the size of data to be transmitted and the mode in transmitting data using microwaves, and when the transmission time period is more than the predetermined value (e.g., one second), establishes a communication link using millimeter waves and transmits data using millimeter waves.

However, millimeter waves are less stable in communication quality than microwaves. Therefore, the control unit 20 transmits data using millimeter waves when the communication quality of millimeter waves is good, and establishes a communication link using microwaves and transmits data using microwaves when the communication quality of millimeter waves is bad.

Note that although the embodiment switches microwaves and millimeter waves depending on the transmission time period calculated from the size of data to be transmitted and the mode in transmitting data using microwaves, no limitation is imposed.

For example, when the size of data to be transmitted is less than or equal to 3 MB, data can be transmitted within one second even in any of the modes A to E. Therefore, the control unit 20 may be configured to transmit data using microwaves when the size of data to be transmitted is less than or equal to 3 MB, and to switch whether to perform transmission using microwaves or millimeter waves based on the transmission time period calculated according to the size of the data and the mode when the size of data to be transmitted is more than 3 MB.

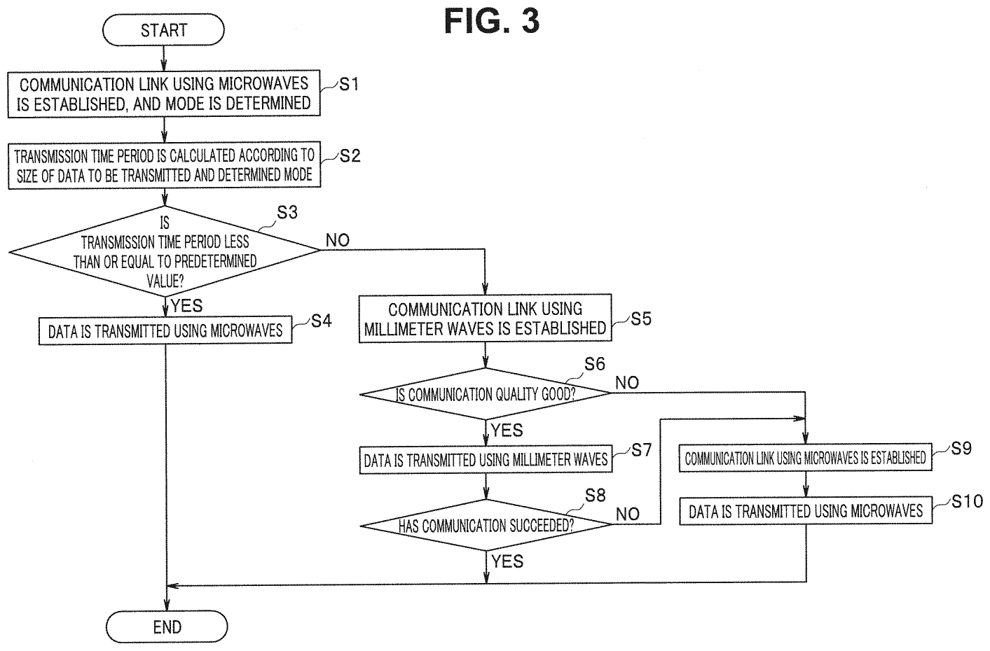

FIG. 3 is a flowchart showing an example flow of switching processing between transmission using microwaves and transmission using millimeter waves.

First, the control unit 20 establishes a communication link using microwaves, and determines a mode (S1). Next, the control unit 20 calculates a transmission time period according to the size of data to be transmitted and the determined mode (S2). Since an effective rate is determined for each of the modes A to E as shown in FIG. 2, the control unit 20 can calculate the transmission time period from the determined mode and the size of transmission data.

Next, the control unit 20 determines whether the transmission time period is less than or equal to the predetermined value (S3). When determining that the transmission time period is less than or equal to the predetermined value (S3: YES), the control unit 20 transmits data using microwaves (S4), and ends the processing.

Note that although set to, for example, one second in the embodiment, the predetermined value may be set to, for example, 0.9 second or 1.1 seconds as appropriate without being limited to one second.

When determining that the transmission time period is not less than or equal to the predetermined value (S3: NO), the control unit 20 establishes a communication link using millimeter waves (S5). When a communication link using millimeter waves has been established, the control unit 20 determines whether the communication quality of millimeter waves is good or not (S6). When determining that the communication quality of millimeter waves is good (S6: YES), the control unit 20 transmits data using millimeter waves (S7). The control unit 20 determines whether communication has succeeded or not (S8). In other words, the control unit 20 determines whether transmission of data using millimeter waves has succeeded or not. When determining that communication has succeeded (S8: YES), the control unit 20 ends the processing.

Thus, the control unit 20 transmits data using millimeter waves when transmitting a large amount of data which takes a longer transmission time period than the predetermined value in transmission using microwaves. However, since the communication quality of millimeter waves is worse than the communication quality of microwaves, transmission of data using millimeter waves may fail when the communication quality of millimeter waves is bad. Therefore, the control unit 20 transmits data using millimeter waves when determining that the communication quality of millimeter waves is good.

When determining that the communication quality of millimeter waves is not good (S6: NO), or when determining that communication has not succeeded (S8: NO), the control unit 20 establishes a communication link using microwaves (S9).

The control unit 20 transmits data using microwaves (S10), and ends the processing.

As described above, when the communication quality of millimeter waves is bad, transmission of data using millimeter waves may fail, and it may take a time period to transmit data. So, when determining that the communication quality of millimeter waves is bad, the control unit 20 again establishes a communication link using microwaves, and transmits data using microwaves.

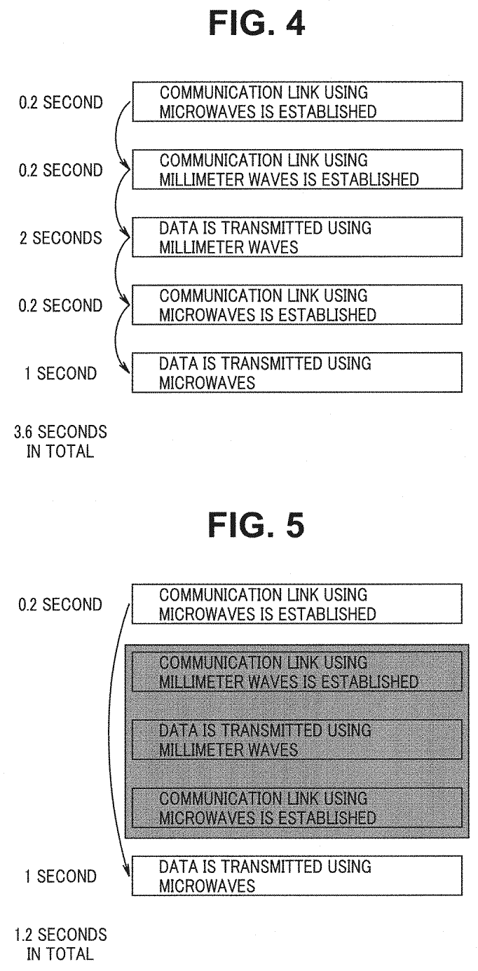

FIG. 4 is a diagram showing an example of conventional switching processing between microwaves and millimeter waves, and FIG. 5 is a diagram showing an example of switching processing between microwaves and millimeter waves in the embodiment. Note that the examples of FIGS. 4 and 5 assume that the mode E is selected in transmitting data using microwaves, and the size of data to be transmitted is 40 MB.

As shown in FIG. 4, it takes 0.2 second to establish a communication link using microwaves. Next, it takes 0.2 second to establish a communication link using millimeter waves. Although data communication using millimeter waves is started when a communication link using millimeter waves has been established, communication environment using millimeter waves is often less stable than communication environment using microwaves in general, and when communication using millimeter waves has failed, it takes an extra time period for data communication. Since communication using millimeter waves has failed and data is repeatedly retransmitted many times here, 2 seconds are taken.

When communication using millimeter waves has failed, it takes 0.2 second to establish communication using microwaves, and data communication using microwaves is performed. The transmission of data using microwaves takes one second because 40 MB of data is transmitted in the mode E.

Thus, when communication using millimeter waves having unstable communication environment has failed in the radio communication module 10 in which both microwaves and millimeter waves are available, 3.6 seconds are taken as a data transmission time period.

In contrast, the embodiment takes 0.2 second to establish a communication link using microwaves as shown in FIG. 5. Here, the transmission time period is calculated as about one second according to the mode in transmission using microwaves, which is the mode E here, and the size of data to be transmitted, which is 40 MB here.

When the transmission time period is within the predetermined value, which is one second here, the control unit 20 does not transition to communication using millimeter waves, but transmits data using microwaves with no change. The transmission of data using microwaves takes one second because 40 MB of data is transmitted in the mode E.

Thus, when the transmission time period in transmitting data using microwaves is within one second, data is transmitted using microwaves without unnecessarily transitioning to millimeter waves, so that the embodiment can reduce the data transmission time period to about 1.2 seconds.

As above, the radio communication module 10 of the embodiment is configured to transmit data by switching microwaves and millimeter waves depending on the transmission time period expected in transmitting data using microwaves. As a result, the radio communication module 10 ceases to unnecessarily transition to millimeter waves worse in communication quality than microwaves, so that data can be transmitted with an optimum transmission time period. For example, the radio communication module 10 can execute immediate data downloading from a digital kiosk or the like within a predetermined time period with high accuracy.

Therefore, according to the radio communication apparatus of the embodiment, the radio communication apparatus in which both microwaves and millimeter waves are available can switch radio communication using microwaves and radio communication using millimeter waves in order to transmit data with an optimum transmission time period.

Note that the respective steps in the flowchart in the present specification may have execution order changed, may be executed in plurality at a same time, or may be executed in a different order for each execution unless contrary to the nature.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

1. A radio communication apparatus including:
a microwave radio unit configured to transmit data using microwaves;
a millimeter wave radio unit configured to transmit the data using millimeter waves; and
a control unit configured to perform control of switching as to whether to transmit the data using the microwaves or the millimeter waves depending on a transmission time period calculated from a mode selected in transmitting the data using the microwaves and a size of the data.

2. The radio communication apparatus according to claim 1, wherein
the control unit determines whether the transmission time period is less than or equal to a predetermined value, and transmits the data using the microwaves when determining that the transmission time period is less than or equal to the predetermined value.

3. The radio communication apparatus according to claim 2, wherein
the control unit determines whether communication quality of the millimeter waves is good or not when determining that the transmission time period is more than the predetermined value, performs control so that the data is transmitted using the millimeter waves when determining that communication quality of the millimeter waves is good, and performs control so that the data is transmitted using the microwaves when determining that communication quality of the millimeter waves is not good.

4. The radio communication apparatus according to claim 1, wherein
the control unit selects a mode in transmission using the microwaves depending on monitored quality of radio communication.

5. The radio communication apparatus according to claim 1, wherein
the control unit selects a mode in transmission using the microwaves depending on a number of times of occurrence of an error in the data during communication.

6. A radio communication terminal including:
a storage unit configured to store data;
a data transfer unit configured to read the data from the storage unit and to transfer the data;
a microwave radio unit configured to transmit the data using microwaves;
a millimeter wave radio unit configured to transmit the data using millimeter waves; and
a control unit configured to perform control of switching as to whether to transmit the data using the microwaves or the millimeter waves depending on a transmission time period calculated from a mode selected in transmitting the data transferred from the data transfer unit using the microwaves and a size of the data.

7. The radio communication terminal according to claim 6, wherein
the control unit determines whether the transmission time period is less than or equal to a predetermined value, and transmits the data using the microwaves when determining that the transmission time period is less than or equal to the predetermined value.

8. The radio communication terminal according to claim 7, wherein
the control unit determines whether communication quality of the millimeter waves is good or not when determining that the transmission time period is more than the predetermined value, performs control so that the data is transmitted using the millimeter waves when determining that communication quality of the millimeter waves is good, and performs control so that the data is transmitted using the microwaves when determining that communication quality of the millimeter waves is not good.

9. The radio communication terminal according to claim 6, wherein
the control unit selects a mode in transmission using the microwaves depending on monitored quality of radio communication.

10. The radio communication terminal according to claim 6, wherein
the control unit selects a mode in transmission using the microwaves depending on a number of times of occurrence of an error in the data during communication.
